(19) United States
(12) Patent Application Publication
(10) Pub. No.: US 2024/0094723 A1
(43) Pub. Date: Mar. 21, 2024

(54) SYSTEMS AND METHODS FOR CONTROLLING A TRAILER VEHICLE

(71) Applicant: Toyota Motor Engineering & Manufacturing North America, Inc., Plano, TX (US)

(72) Inventor: Paxton S. Williams, Milan, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 17/946,210

(22) Filed: Sep. 16, 2022

(51) Int. Cl. G05D 1/00; B60W 40/105

(52) U.S. Cl. CPC G05D 1/0027; B60W 40/105; B60W 2300/14; B60W 2554/80

(57) ABSTRACT

Systems, methods, and other embodiments described herein relate to controlling an untethered trailer vehicle. In one embodiment, a method includes receiving sensor data about at least one vehicle between a tow vehicle and at least one trailer vehicle and outputting, using an output system, information related to the at least one vehicle and the at least one trailer vehicle based on the sensor data. The method includes receiving from a user, using an input system, a new position for at least one trailer vehicle relative to the at least one vehicle and transmitting the new position to the at least one trailer vehicle.

### FIELD

The subject matter described herein relates in general to controlling trailer vehicles and, more particularly, to controlling untethered trailer vehicles.

### BACKGROUND

Some tow vehicles have to be physically tethered to the tow vehicle. However, a tow vehicle physically tethered or attached to one or more trailer vehicles may be cumbersome to navigate. As an example, the tow vehicle and the trailer vehicles may experience difficulty changing from one lane to another because of the length of the tow vehicle and the trailer vehicles.

### SUMMARY

This section generally summarizes the disclosure and is not a comprehensive explanation of its full scope or all its features.

In one embodiment, a method for controlling a trailer vehicle is disclosed. The method includes receiving sensor data about at least one vehicle between a tow vehicle and at least one trailer vehicle. The method includes outputting, using an output system, information related to the at least one vehicle and the at least one trailer vehicle based on the sensor data, and receiving from a user, using an input system, a new position for at least one trailer vehicle relative to the at least one vehicle. The method includes transmitting the new position to the at least one trailer vehicle.

In another embodiment, a system for controlling a trailer vehicle is disclosed. The system includes a processor and a memory in communication with the processor. The memory stores machine-readable instructions that, when executed by the processor, cause the processor to receive sensor data about at least one vehicle between a tow vehicle and at least one trailer vehicle and output, using an output system, information related to the at least one vehicle and the at least one trailer vehicle based on the sensor data. The memory stores machine-readable instructions that, when executed by the processor, cause the processor to receive from a user, using an input system, a new position for at least one trailer vehicle relative to the at least one vehicle and transmit the new position to the at least one trailer vehicle.

In another embodiment, a non-transitory computer-readable medium for controlling a trailer vehicle and including instructions that, when executed by a processor, cause the processor to perform one or more functions, is disclosed. The instructions include instructions to receive sensor data about at least one vehicle between a tow vehicle and at least one trailer vehicle and output, using an output system, information related to the at least one vehicle and the at least one trailer vehicle based on the sensor data. The instructions include instructions to receive from a user, using an input system, a new position for at least one trailer vehicle relative to the at least one vehicle and transmit the new position to the at least one trailer vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates a block diagram of a tow vehicle incorporating an untethered towing system.

FIG. 2 is a more detailed block diagram of the untethered towing system of FIG. 1.

FIG. 3 is an example of a method for controlling an untethered trailer vehicle.

FIGS. 4A-4F are an example of an untethered towing control scenario.

### DETAILED DESCRIPTION

Systems, methods, and other embodiments associated with controlling one or more untethered trailer vehicles are disclosed.

A towing vehicle can tow a trailer vehicle that is untethered to the towing vehicle. An untethered trailer vehicle is not physically attached to the towing vehicle. As such, there is a likelihood that the towing vehicle and the trailer vehicle can be separated from each other. Other vehicles alongside the towing vehicle and the trailer vehicle may intercept and begin to travel between the towing vehicle and the trailer vehicle.

The trailer vehicle may be autonomous while the towing vehicle may be manual or autonomous. There may be a single trailer or multiple trailer vehicles travelling with the tow vehicle. A user travelling in the towing vehicle may control the one or more trailer vehicles using an untethered towing system.

As an example, the untethered towing system may receive sensor data relating to the environment around the towing vehicle and the trailer vehicle(s) from multiple sources including vehicle sensors, roadside sensors, a satellite system, and/or a Global Positioning System (GPS). Using this sensor data, the untethered towing system maps out an overhead view of the environment surrounding the towing vehicle and the trailer vehicle(s). The overhead view displays vehicles traveling alongside the tow vehicle and the trailer vehicles. Particularly, the overhead view displays vehicles between the tow vehicle and the trailer vehicle(s). The untethered towing system displays the overhead view on a display which may be located in the tow vehicle and/or a mobile device. The display is visible to the user. The display may include information about the tow vehicle, the trailer vehicle(s), and/or other vehicles in the environment. The information may include speed and direction of travel, type, brand and/or model of vehicle.

The untethered towing system may constantly update the display. Alternatively, the untethered towing system may update the display based on certain conditions being met. As an example, the untethered towing system may monitor the environment and when the number of vehicles between the towing vehicle and the trailer vehicle exceed a predetermined value, the untethered towing system may alert the user by emitting a sound and/or outputting a message or graphic on the display. As another example, the untethered towing system may monitor the environment and when the distance between the towing vehicle and the trailer vehicle exceeds a predetermined distance, the untethered towing system may alert the user by emitting a sound and/or outputting a message or graphic on the display.

Using an input interface such as a touchscreen, the user can select a new position for the trailer vehicle. In a case where there are multiple trailer vehicles, the user can first select a trailer vehicle, then select the new position for the selected trailer vehicle.

The trailer vehicle may be positioned at any location relative to the tow vehicle. As an example, the trailer vehicle may be behind the tow vehicle, beside the tow vehicle, or in front of the tow vehicle. The trailer vehicle may be in the same lane as the tow vehicle or may be in a different lane from the tow vehicle. The new position may be any location relative to the tow vehicle. As an example, the new position may be located between the tow vehicle and another vehicle or between two vehicles (none of which are the tow vehicle).

Upon receiving an input from the user indicating the new position, the untethered towing system communicates with the trailer vehicle and instructs the trailer vehicle to travel to the new position. The untethered towing system may further determine a route to the new position and one or more instructions based on the route. The untethered towing system may transmit the route and/or the instruction(s) to the trailer vehicle. The untethered towing system may determine that the trailer vehicle has successfully travelled to the new position or that the trailer vehicle has not been successful in travelling to the new position using one of sensors and communicating with the trailer vehicle. In such a case, the untethered towing system may request and receive the position or location of the trailer vehicle from the trailer vehicle.

In the case that the trailer vehicle is successful, the untethered towing system may output a status update for the user. The untethered towing system may update the display accordingly. In the case that the trailer vehicle is unsuccessful, the trailer vehicle may attempt several times before giving up. When the trailer vehicle is unsuccessful, the untethered towing system may determine another route to the new position and/or new instructions based on the other route. The untethered towing system may then transmit the other route and/or the new instructions based on the other route. The untethered towing system may output a status update when the trailer vehicle is unsuccessful.

Current technologies do not disclose being able to control an untethered trailer vehicle. Specifically, current technology does not disclose being able to instruct a trailer vehicle to a position between two vehicles where the vehicles may be in motion.

The embodiments disclose herein present various advantages over current technologies. First, the embodiments can assist the user in keeping the trailer vehicle(s) within the field of view of the user. Second, the embodiments can assist the user in controlling the trailer vehicle at a fine granularity such as selecting a specific new position between two vehicles, determining the route and instructions to the new position. Third, the untethered towing system makes the tow vehicle and the trailer vehicle(s) nimble as the tow vehicle and the trailer vehicle(s) may more easily navigate an environment when the towing vehicle and the trailer vehicle are separated.

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in the figures, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

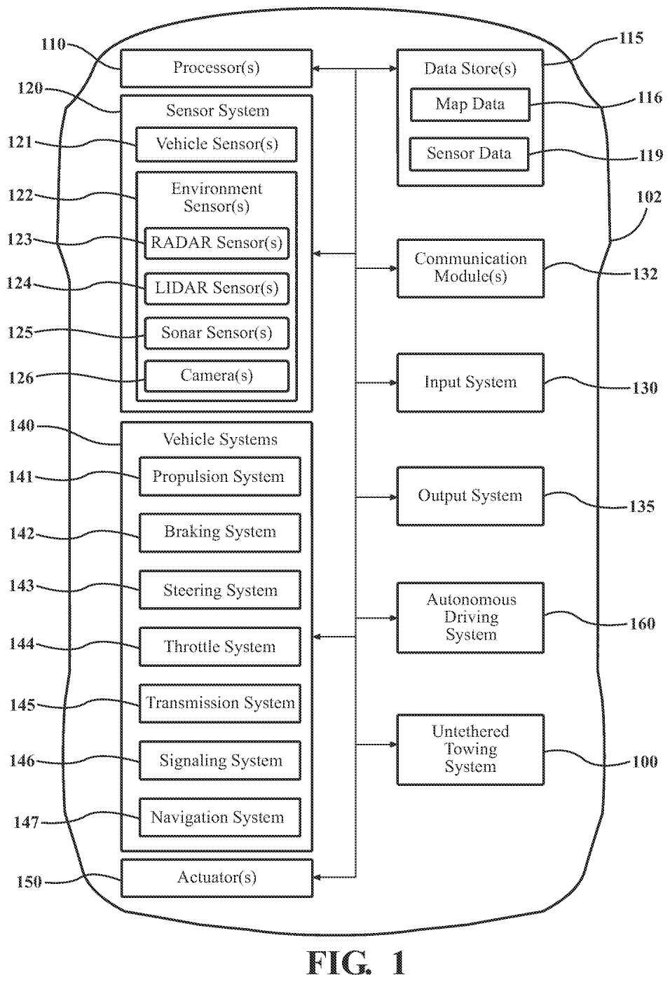

Referring to FIG. 1, a block diagram of a vehicle 102 incorporating an untethered towing system 100 is illustrated. The tow vehicle 102 includes various elements. It will be understood that in various embodiments, it may not be necessary for the tow vehicle 102 to have all of the elements shown in FIG. 1. The tow vehicle 102 can have any combination of the various elements shown in FIG. 1. Further, the tow vehicle 102 can have additional elements to those shown in FIG. 1. In some arrangements, the tow vehicle 102 may be implemented without one or more of the elements shown in FIG. 1. While the various elements are shown as being located within the tow vehicle 102 in FIG. 1, it will be understood that one or more of these elements can be located external to the tow vehicle 102. Further, the elements shown may be physically separated by large distances. For example, as discussed, one or more components of the disclosed system can be implemented within a vehicle while further components of the system can be implemented within a cloud-computing environment.

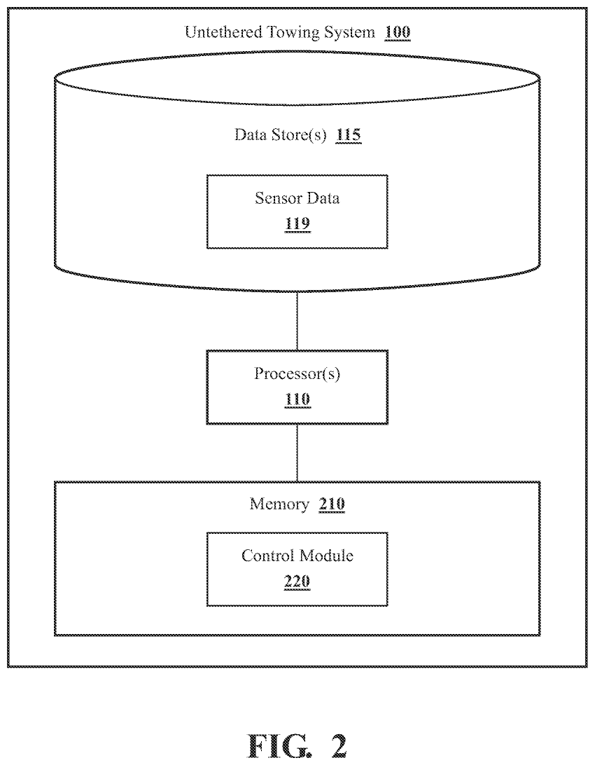

Some of the possible elements of the tow vehicle 102 are shown in FIG. 1 and will be described along with subsequent figures. However, a description of many of the elements in FIG. 1 will be provided after the discussion of FIGS. 2-4 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In any case, as illustrated in the embodiment of FIG. 1, the tow vehicle 102 includes an untethered towing system 100 that is implemented to perform methods and other functions as disclosed herein relating to controlling a trailer vehicle, specifically an untethered trailer vehicle. As an example, the untethered towing system 100, in various embodiments, may be implemented partially within the tow vehicle 102 and may further exchange communications with additional aspects of the untethered towing system 100 that are remote from the tow vehicle 102 in support of the disclosed functions. Thus, while FIG. 2 generally illustrates the untethered towing system 100 as being self-contained, in various embodiments, the untethered towing system 100 may be implemented within multiple separate devices some of which may be remote from the tow vehicle 102.

With reference to FIG. 2, a more detailed block diagram of the untethered towing system 100 is shown. The untethered towing system 100 may include a processor(s) 110. Accordingly, the processor(s) 110 may be a part of the untethered towing system 100, or the untethered towing system 100 may access the processor(s) 110 through a data bus or another communication pathway. In one or more embodiments, the processor(s) 110 is an application-specific integrated circuit that may be configured to implement functions associated with a control module 220. More generally, in one or more aspects, the processor(s) 110 is an electronic processor, such as a microprocessor that can perform various functions as described herein when loading the control module 220 and executing encoded functions associated therewith.

The untethered towing system 100 may include a memory 210 that stores the control module 220. The memory 210 may be a random-access memory (RAM), read-only memory (ROM), a hard disk drive, a flash memory, or other suitable memory for storing the control module 220. The control module 220 is, for example, a set of computer-readable instructions that, when executed by the processor(s) 110, cause the processor(s) 110 to perform the various functions disclosed herein. While, in one or more embodiments, the control module 220 is a set of instructions embodied in the memory 210, in further aspects, the control module 220 include hardware, such as processing components (e.g., controllers), circuits, etc. for independently performing one or more of the noted functions.

The untethered towing system 100 may include a data store(s) 115 for storing one or more types of data. Accordingly, the data store(s) 115 may be a part of the untethered towing system 100, or the untethered towing system 100 may access the data store(s) 115 through a data bus or another communication pathway. The data store(s) 115 is, in one embodiment, an electronically based data structure for storing information. In at least one approach, the data store 115 is a database that is stored in the memory 210 or another suitable medium, and that is configured with routines that can be executed by the processor(s) 110 for analyzing stored data, providing stored data, organizing stored data, and so on. In either case, in one embodiment, the data store 115 stores data used by the control module 220 in executing various functions. In one embodiment, the data store 115 may be able to store sensor data 119 and/or other information that is used by the control module 220.

The data store(s) 115 may include volatile and/or non-volatile memory. Examples of suitable data stores 250 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 may be a component of the processor(s) 110, or the data store(s) 115 may be operatively connected to the processor(s) 110 for use thereby. The term “operatively connected” or “in communication with” as used throughout this description, can include direct or indirect connections, including connections without direct physical contact.

In one or more arrangements, the data store(s) 115 can include sensor data 119. The sensor data 119 can originate from the sensor system 120 of the tow vehicle 102. The sensor data 119 can include data from visual sensors, audio sensors, and/or any other suitable sensors in the tow vehicle 102. Additionally and/or alternatively, the sensor data 119 can originate from the trailer vehicle(s), other vehicle(s), and/or other objects such as roadside infrastructure.

As an example, the sensor data 119 can include geographic coordinates of the tow vehicle 102, the trailer vehicle, and/or any vehicles or objects surrounding the tow vehicle 102 or the trailer vehicle. As another example, the sensor data 119 can include relative positions of the tow vehicle 102, the trailer vehicle(s), and/or any vehicles or objects surrounding the tow vehicle 102 or the trailer vehicle. In such an example, the sensor data 119 can include positions of the tow vehicle 102, trailer vehicle(s), and any other vehicle relative to each other. As another example, the sensor data 119 can include that the tow vehicle 102 and the trailer vehicle(s) are in the same lane with three vehicles between the tow vehicle 102 (being ahead of the three vehicles) and the trailer vehicle (being behind the three vehicles). As another example, the sensor data 119 can include that the tow vehicle 102 and the trailer vehicle are two different lanes with two vehicles between the tow vehicle 102 (which is ahead of the two vehicles) and the trailer vehicle (which is behind the two vehicles). In such an example, the two vehicles between the tow vehicle 102 and the trailer vehicle may be along a longitudinal direction.

The sensor data 119 may include characteristics of the tow vehicle 102, the trailer vehicle(s), and/or the vehicle(s) and objects surrounding the tow vehicle 102 or the trailer vehicle. As an example, the characteristics may include the brand, model, and/or type of the tow vehicle 102, the trailer vehicle(s), and/or the vehicle(s) and objects surrounding the tow vehicle 102 or the trailer vehicle. As another example, the characteristics may include whether the tow vehicle 102, the trailer vehicle(s), and/or the vehicle(s) and objects surrounding the tow vehicle 102 or the trailer vehicle are stationary or mobile. In the case where the tow vehicle 102, the trailer vehicle(s), and/or the vehicle(s) and objects surrounding the tow vehicle 102 or the trailer vehicle are mobile, the characteristics may include the speed of travel and the direction of travel for the tow vehicle 102, the trailer vehicle(s), and/or the vehicle(s) and objects surrounding the tow vehicle 102 or the trailer vehicle.

In one embodiment, the control module 220 may include instructions that, when executed by the processor(s) 110, cause the processor(s) 110 to receive sensor data 119 about at least one vehicle between the tow vehicle 102 and at least one trailer vehicle. As an example, the control module 220 may receive sensor data 119 from sensor(s) of the tow vehicle 102, sensor(s) of the trailer vehicle(s), sensor(s) of the vehicle(s) or object(s) between the tow vehicle 102 and the trailer vehicle(s), and/or sensor(s) of roadside infrastructure.

The control module 220 may determine positions and/or speeds of the tow vehicle 102, the trailer vehicle(s), and the vehicle(s) between the tow vehicle 102 and the trailer vehicle(s) based on the sensor data 119. As an example, the sensor data 119 may include the GPS coordinates of the tow vehicle 102, the trailer vehicle(s), and the vehicle(s) between the tow vehicle 102 and the trailer vehicle(s). The control module 220 may determine the relative positions and the speeds of the tow vehicle 102, the trailer vehicle(s), and/or the vehicle(s) between the tow vehicle 102 and the trailer vehicle(s) based on the GPS coordinates.

As another example, the control module 220 may control the tow vehicle 102 or more specifically, control the communication module(s) 132 to communicate with the trailer vehicle(s) and the vehicle(s) between the tow vehicle 102 and the trailer vehicle(s) using the communication module(s) 132. The control module 220 may receive the speed, location, and direction of travel from the trailer vehicle(s) and/or the vehicle(s) between the tow vehicle 102 and the trailer vehicle(s). The control module 220 may determine positions of the tow vehicle 102, the trailer vehicle(s), and the vehicle(s) between the tow vehicle 102 and the trailer vehicle(s) based on the speed(s), location(s), and direction(s) of travel received.

As another example, the control module 220 may control the tow vehicle 102 or more specifically, control the communication module(s) to communicate with the roadside infrastructure using wireless communication such as vehicle-to-infrastructure (V2I) or vehicle-to-everything (V2X) communication. The control module 220 may receive the speed, location, and direction of travel from the roadside infrastructure. The control module 220 may determine positions of the tow vehicle 102, the trailer vehicle(s), and the vehicle(s) between the tow vehicle 102 and the trailer vehicle(s) based on the speed(s), location(s), and direction(s) of travel received from the roadside infrastructure.

As another example, the control module 220 may control the tow vehicle 102 to communicate with the trailer vehicle(s) through the vehicle(s) between the tow vehicle 102 and the trailer vehicles. In such an example, the tow vehicle 102 and/or the trailer vehicle may count the number of vehicles that participated in the communication. As an example, there are three vehicles, a first vehicle, a second vehicle, and a third vehicle, between the tow vehicle 102 and the trailer vehicle. The first vehicle is directly behind the tow vehicle 102, the second vehicle is directly behind the first vehicle, and third vehicle is directly behind the second vehicle and in front of the trailer vehicle. The tow vehicle 102 may communicate with the first vehicle which may transmit a position of 1 to the tow vehicle 102 and/or the second vehicle. The second vehicle, in response to receiving the transmission from the first vehicle, may transmit a position of 2 to the tow vehicle 102, the first vehicle, and/or the third vehicle. The third vehicle, in response to receiving the transmission from the second vehicle, may transmit a position of 3 to the tow vehicle 102, the first vehicle, the second vehicle, and/or the trailer vehicle. In this example, the tow vehicle 102 may determine the number of vehicles between the tow vehicle 102 and the trailer vehicle(s) is 3. As such, the tow vehicle 102 may determine the number of vehicles and the positions of the vehicles between the tow vehicle 102 and the trailer vehicle by communicating with the vehicles between the tow vehicle 102 and the trailer vehicle. In addition to transmitting their positions to the tow vehicle 102, the trailer vehicle(s), and each other, the vehicles in between the tow vehicle 102 and the trailer vehicle(s) may transmit information such as a model type, a brand, a speed of travel, and/or a direction of travel.

The control module 220 may estimate the time it would take for the trailer vehicle to travel from its present position to a position directly behind the tow vehicle 102 with no vehicles between the tow vehicle 102 and the trailer vehicle(s). The control module 220 may utilize any suitable process or algorithm to determine the relative positions and the speeds of the tow vehicle 102, the trailer vehicle(s), and the vehicles between the tow vehicle 102 and the trailer vehicle(s). Further, the control module 220 may utilize any suitable process and/or algorithm to estimate the time it would take for the trailer vehicle to travel from its present position to the position directly behind the tow vehicle 102 with no vehicles between the tow vehicle 102 and the trailer vehicle(s). The control module 220 may use a navigation application such as Google Maps or Apple Maps to estimate the time it would take for the trailer vehicle to travel from its present position to the position directly behind the tow vehicle 102 with no vehicles between the tow vehicle 102 and the trailer vehicle(s).

The control module 220 may include instructions that, when executed by the processor(s) 110, cause the processor(s) 110 to output, using an output system 135, information related to the at least one vehicle and the at least one trailer vehicle based on the sensor data 119. The information may include a relative position of the tow vehicle 102, a relative position of the at least one vehicle between the tow vehicle 102 and the trailer vehicle(s), and/or a relative position of the trailer vehicle. In other words, the information may include the positions of the tow vehicle 102, the trailer vehicle, and the vehicle(s) between the tow vehicle and the trailer vehicle(s) relative to each other.

The information may include a speed of the tow vehicle 102, a speed of the at least one vehicle, and a speed of the trailer vehicle(s). The speed of the at least one vehicle refers to the speed of the vehicle(s) between the tow vehicle and the trailer vehicle(s) and/or any other vehicles in the surroundings. The control module 220 may determine the speeds of the tow vehicle 102, the trailer vehicle(s), and the vehicle(s) between the tow vehicle 102 and the trailer vehicle(s) as described above. The information may include an estimate of time needed for the at least one trailer vehicle to be behind the tow vehicle 102 with no other vehicle in between the tow vehicle 102 and the at least one trailer vehicle. The control module 220 may estimate the time as described above. The information may be in any suitable format such as a visual format or an audio format. In a visual format, the output system 135 may display text and/or graphics.

The control module 220 may include instructions that, when executed by the processor(s) 110, cause the processor(s) 110 to determine whether a condition has been met and to output, using the output system 135, an alert based on determining that the condition has been met. As such and as an example, the control module 220, in response to the condition not being met, may not output, using the output system 135, an alert.

The condition may be a distance between the tow vehicle 102 and the at least one trailer vehicle exceeding predetermined distance. In other words, the condition may be that the trailer vehicle is lagging behind the tow vehicle 102 and is over predetermined distance from the tow vehicle 102. As an example, the condition may be met when the predetermined distance is 150 feet and the distance between the tow vehicle 102 and the trailer vehicle is 155 feet, exceeding the predetermined distance. As such and as an example, the condition may not be met when the distance between the tow vehicle 102 and the trailer vehicle is 130 feet, which does not exceed the predetermined distance. As an example, the control module 220 may determine the distance between tow vehicle 102 and the trailer vehicle based on sensor data or communication between the tow vehicle 102 and the trailer vehicle.

The condition may be a number of vehicles between the tow vehicle 102 and the at least one trailer vehicle exceeding a predetermined number. In other words, the condition may be that the tow vehicle 102 and the trailer vehicle are separated by a number of vehicles between the tow vehicle 102 and the trailer vehicle and the number of vehicles between exceed a predetermined number. As an example, the condition may be met when the predetermined number is 6 and the number of vehicles between the tow vehicle 102 and the trailer vehicle is 8, exceeding the predetermined number. As such and as an example, the condition may not be met when the number of vehicles between the tow vehicle 102 and the trailer vehicle is 4, which does not exceed the predetermined number. The control module 220 may determine the number of vehicles between the tow vehicle 102 and trailer vehicle(s) as described above.

The control module 220 may output, using the output system 135, an alert in response to the condition being met. As an example, may output a sound, a graphic, and/or a text indicating to the user that the condition has been met. In such an example, the control module 220 may further inquire whether the user would like to control and/or navigate the trailer vehicle into a new position.

The control module 220 may include instructions that, when executed by the processor(s) 110, cause the processor(s) 110 to receive from a user, using an input system 130, a new position for at least one trailer vehicle relative to the at least one vehicle. The input system 130 may be an interface in the tow vehicle 102 and/or an interface on a mobile device. As an example, the input system 130 may be a microphone that receives a voice command from the user. As another example, the input system 130 may be a touch screen that receives a command from the user when the user touches the touchscreen.

As an example, there may be one vehicle between the tow vehicle 102 and the trailer vehicle. In such an example, the user may select the new position to be ahead of the one vehicle and as such, the new position is between the one vehicle and the tow vehicle 102. In such an example, the new position is ahead of all the vehicle(s) between the tow vehicle 102 and the trailer vehicle.

As another example, there may be at least two vehicles between the tow vehicle 102 and the trailer vehicle. In such an example, the user may select the new position to be between the at least two vehicles. Alternatively, the user may select the new position to be ahead of the at least two vehicles. In other words, the user may select the new position to be behind the tow vehicle 102 with no other vehicle between the tow vehicle 102 and the new position. As an example where there are four vehicles in a row (a first vehicle, a second vehicle, a third vehicle, and a fourth vehicle) between the tow vehicle 102 and the trailer vehicle, the new position may be between the tow vehicle 102 and the first vehicle, between the first vehicle and the second vehicle, between the second vehicle and the third vehicle, or between the third vehicle and the fourth vehicle. The user may select the new position using any suitable manner. As an example, the user may use an audio command identify the new position and instruct the trailer vehicle to move to the new position. As another example, the user may touch a location on the touchscreen to indicate the new position. In such an example, the user may touch a location between the graphics of the tow vehicle 102 and the first vehicle to indicate that that is the new position. As an example and in a case where there are multiple trailer vehicles, the user may select a trailer vehicle and then select a new position for the selected trailer vehicle.

The control module 220 may include instructions that, when executed by the processor(s) 110, cause the processor(s) 110 to transmit the new position to the at least one trailer vehicle. The control module 220, in response to receiving the user input indicating the new position, may transmit the new position to the trailer vehicle. The control module 220 may transmit the new position to the trailer vehicle using the communication module(s) 132. As an example, the control module 220 may transmit the new position in terms of the number of vehicles that the trailer vehicle has to overtake. In such an example, if there are four vehicles between the tow vehicle and the trailer vehicle, the control module may communicate to the trailer vehicle that the trailer vehicle overtake one vehicle ahead of the trailer vehicle, two vehicles ahead of the trailer vehicle, three vehicles ahead of the trailer vehicle, or all four vehicles ahead of the trailer vehicle. As another example, the control module 220 may transmit the new position as geographic coordinates that is constantly updated as the vehicles proximate to the geographic coordinates move.

The control module 220 may include instructions that, when executed by the processor(s) 110, cause the processor(s) 110 to determine a route to the new position, generate at least one instruction based on the route, and transmit at least one of the route or the at least one instruction to the at least one trailer vehicle. The control module 220 may determine the route to the new position using any suitable routing or navigational process. The control module 220 may determine the route to the new position based on the positions, speeds, directions, and/or lanes of travel of the tow vehicle 102, the trailer vehicle(s), and the vehicle(s) between the tow vehicle 102 and the trailer vehicle(s).

The instruction(s) based on the route may be a single instruction to the trailer vehicle such as “Overtake the vehicle in front of you”, “Overtake two vehicles in front of you”, or “Move over to the left by one lane”. Alternatively, the instructions may be a series of instructions to the trailer vehicle such as “Move over to the left by one lane, increase speed by 10 mph, maintain speed for 1 mile, move over to the right by one lane.” The control module 220 may transmit the instructions to the trailer vehicle(s) in any suitable manner.

The control module 220 may include instructions that, when executed by the processor(s) 110, cause the processor(s) 110 to determine a status update of the at least one trailer vehicle. As an example, the control module 220 may monitor the position of the trailer vehicle using the sensor system 120 to determine whether the trailer vehicle has successfully travelled into the new position. As another example, the control module 220 may receive a status update from the trailer vehicle(s) indicating whether the trailer vehicle was successful in travelling to the new position or unsuccessful in travelling to the new position. In the case where the trailer vehicle was unsuccessful, the control module 220 may receive a status update indicating whether the trailer vehicle has given up or intends to make another attempt to travel to the new position. In response to receiving the status update that the trailer vehicle was unsuccessful, the control module 220 may determine and transmit to the trailer vehicle another route and/or instruction(s) based on the other route. The control module 220 may output, using the output system 135, the status update of the trailer vehicle(s) to the user.

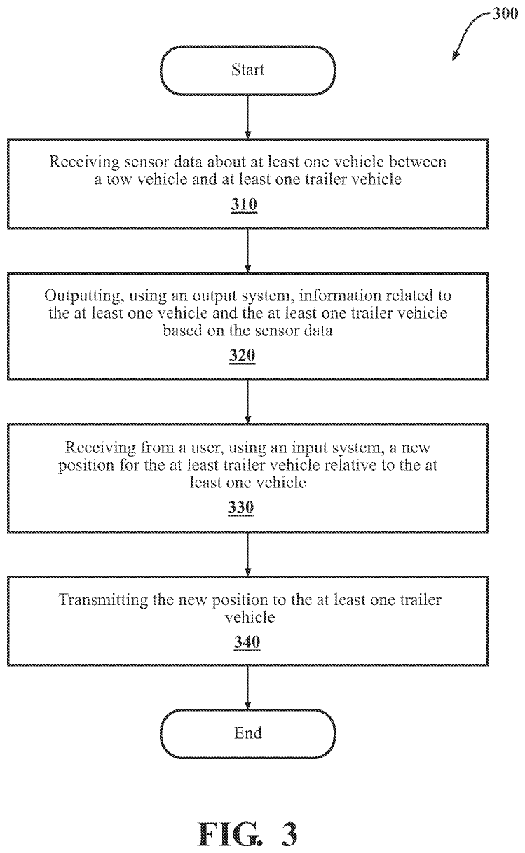

FIG. 3 illustrates a method 300 for controlling an untethered trailer vehicle. The method 300 will be described from the viewpoint of the tow vehicle 102 of FIG. 1 and the untethered towing system of FIG. 2. However, the method 300 may be adapted to be executed in any one of several different situations and not necessarily by the tow vehicle of FIG. 1 and/or the untethered towing system of FIG. 2.

At step 310, the control module 220 may cause the processor(s) 110 to receive sensor data about at least one vehicle between the tow vehicle 102 and at least one trailer vehicle. As previously mentioned and as an example, the control module 220 may receive sensor data 119 from the sensor system 120 in the tow vehicle 102, the trailer vehicle(s), and/or other vehicle(s) and object(s) in the environment of the tow vehicle 102 and the trailer vehicle(s).

At step 320, the control module 220 may cause the processor(s) 110 to output, using the output system 135, information related to the at least one vehicle and the at least one trailer vehicle based on the sensor data 119. The information, as previously mentioned, may include the relative positions of the tow vehicle 102, the at least one vehicle, and the at one least trailer vehicle. The information may further include a speed of the tow vehicle 102, the at least one vehicle, and the at least one trailer vehicle. The information may include an estimate of time needed for the at least one trailer vehicle to travel from its present position to being behind the tow vehicle 102 with no other vehicle in between the tow vehicle 102 and the at least one trailer vehicle. The information may further include a status update of the trailer vehicle(s). The control module 220 may determine the status update as previously disclosed.

The control module 220 may periodically output the information. Alternatively, the control module 220 may output the information in response to a condition being met. As previously disclosed, the condition may be a distance between the tow vehicle 102 and the at least one trailer vehicle exceeding predetermined distance or a number of vehicles between the tow vehicle 102 and the at least one trailer vehicle exceeding a predetermined number. In the case where one of the conditions is met, the control module 220 may alert the user using any suitable form and may output information relating to the condition that has been met on the output system 135.

At step 330, the control module 220 may cause the processor(s) 110 to receive from a user, using the input system 130, a new position for at least one trailer vehicle relative to the at least one vehicle. As previously mentioned, the new position may be any position behind the tow vehicle 102 and ahead of the trailer vehicle(s). The user may enter the new position as disclosed above.

At step 340, the control module 220 may cause the processor(s) 110 to transmit the new position to the at least one trailer vehicle. The control module 220 may determine a route to the new position, generate instruction(s) based on the route, and transmit at least one of the route or the instruction(s) to the trailer vehicle. In response to a status update indicating that the trailer vehicle was unsuccessful in traveling to the new position, the control module 220 may determine another new route, generate instruction(s) based on the new route, and transmit at least one of the new route or the new instruction(s) to the trailer vehicle.

The method 300 can end. Alternatively, the method 300 can return to step 310 or some other step.

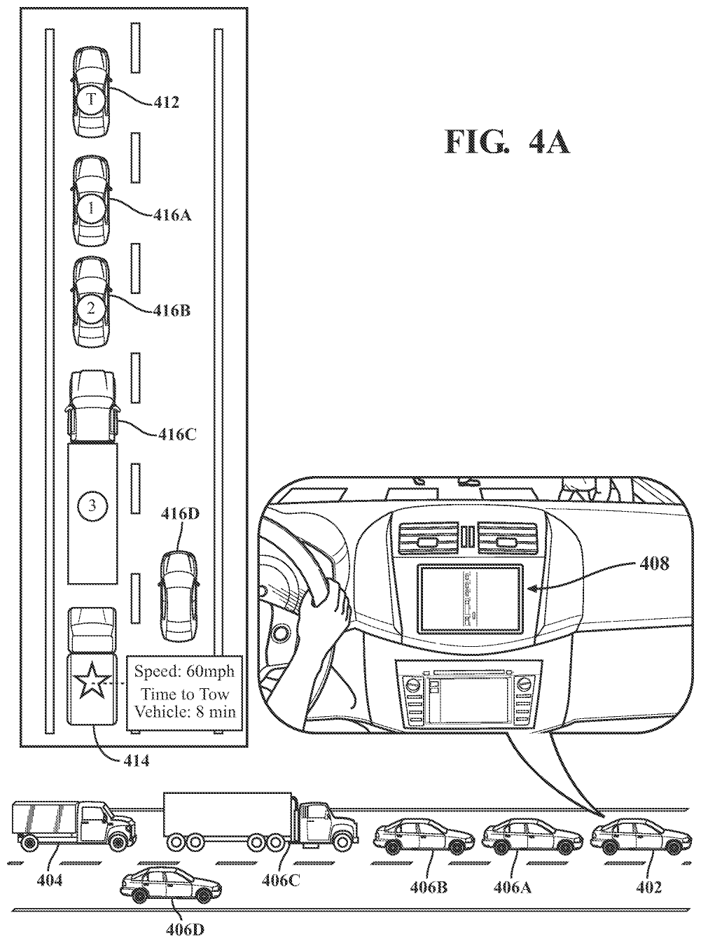

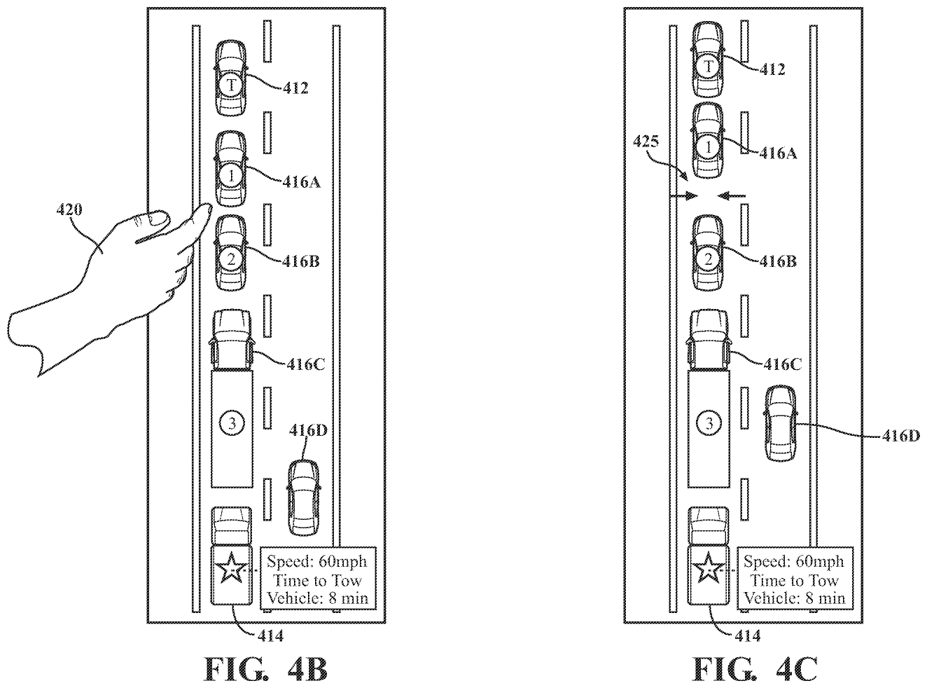

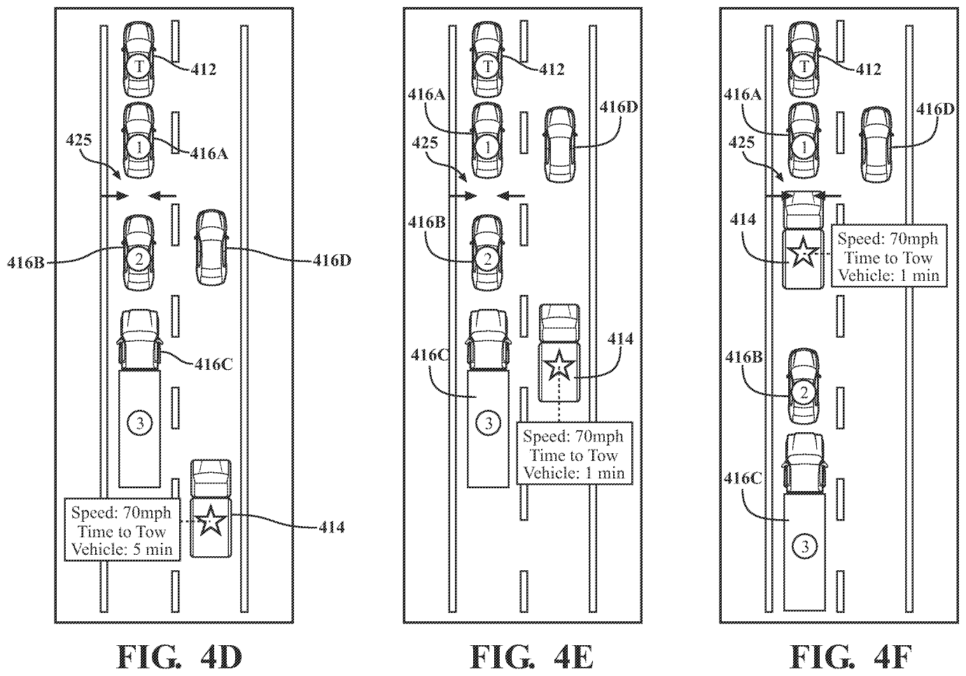

A non-limiting example of the operation of the untethered towing system 100 and/or one or more of the methods will now be described in relation to FIGS. 4A-4F. FIG. 4A shows an example of a driving scenario with the tow vehicle 402 separated from the trailer vehicle 404 by vehicles 406A, 406B, 406C. The untethered towing system 400 (similar to the untethered towing system 100) receives sensor data 119 from the tow vehicle 402, the trailer vehicle 404, and the surrounding vehicles 406A, 406B, 406C, 406D (collectively known as 406). The tow vehicle 402 includes a touchscreen 408. The touchscreen 408 is a part of the output system 135 and the input system 130. The touchscreen 408 illustrates the relative positions 412, 414, 416A, 416B, 416C, 416D of the tow vehicle 402, the trailer vehicle 404, and the surrounding vehicles 406 based on sensor data 119 received by the untethered towing system 400. The touchscreen 408 may also display information about the tow vehicle 402, trailer vehicle 404, and the surrounding vehicles 406. For clarity, only information for the trailer vehicle 404 is illustrated in FIG. 4A.

As shown in FIG. 4B, the user 420 identifies a new position 425 for the trailer vehicle 404 by touching a position between the graphics 416A and 416B illustrating vehicles 406A, 406B on the touchscreen 408. The control module 220 receives the inputted new position 425 from the user, displays the new position 425, and transmits the new position 425 to the trailer vehicle 404.

The control module 220 controls the tow vehicle 402 to communicate with the trailer vehicle 404 using the communication module(s) 132. The control module 220 instructs the trailer vehicle 404 to overtake the two vehicles 406B, 406C in front of the trailer vehicle 404. In response and as shown in FIGS. 4C-4F, the trailer vehicle 404 moves into the right lane, overtakes two vehicles 406B, 406C and returns to the left lane behind the vehicle 406A. The control module 220 determines the trailer vehicle 404 is now in the new position 425 using sensor data 119. The control module 220 indicates to the user that the trailer vehicle 404 successfully completed the move to the new position 425 and clears the graphic indicating the new position from the touchscreen 408.

FIG. 1 will now be discussed in full detail as an example environment within which the system and methods disclosed herein may operate. In some instances, the tow vehicle 102 is configured to switch selectively between an autonomous mode, one or more semi-autonomous operational modes, and/or a manual mode. Such switching can be implemented in a suitable manner, now known or later developed. “Manual mode” means that all of or a majority of the navigation and/or maneuvering of the vehicle is performed according to inputs received from a user (e.g., human driver). In one or more arrangements, the tow vehicle 102 can be a conventional vehicle that is configured to operate in only a manual mode.

In one or more embodiments, the tow vehicle 102 is an autonomous vehicle. As used herein, “autonomous vehicle” refers to a vehicle that operates in an autonomous mode. “Autonomous mode” refers to navigating and/or maneuvering the tow vehicle 102 along a travel route using one or more computing systems to control the tow vehicle 102 with minimal or no input from a human driver. In one or more embodiments, the tow vehicle 102 is highly automated or completely automated. In one embodiment, the tow vehicle 102 is configured with one or more semi-autonomous operational modes in which one or more computing systems perform a portion of the navigation and/or maneuvering of the vehicle along a travel route, and a vehicle operator (i.e., driver) provides inputs to the vehicle to perform a portion of the navigation and/or maneuvering of the tow vehicle 102 along a travel route.

The tow vehicle 102 can include one or more processors 110. In one or more arrangements, the processor(s) 110 can be a main processor of the tow vehicle 102. For instance, the processor(s) 110 can be an electronic control unit (ECU). The tow vehicle 102 can include one or more data stores 115 for storing one or more types of data. The data store 115 can include volatile and/or non-volatile memory. Examples of suitable data stores 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store 115 can be a component of the processor(s) 110, or the data store 115 can be operatively connected to the processor(s) 110 for use thereby. The term “operatively connected,” as used throughout this description, can include direct or indirect connections, including connections without direct physical contact.

In one or more arrangements, the one or more data stores 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

The one or more data stores 115 can include sensor data 119. In this context, “sensor data” means any information about the sensors that the tow vehicle 102 is equipped with, including the capabilities and other information about such sensors. As will be explained below, the tow vehicle 102 can include the sensor system 120. The sensor data 119 can relate to one or more sensors of the sensor system 120. As an example, in one or more arrangements, the sensor data 119 can include information on one or more vehicle sensors 121 and/or environment sensors 122 of the sensor system 120.

In some instances, at least a portion of the map data 116 and/or the sensor data 119 can be located in one or more data stores 115 located onboard the tow vehicle 102. Alternatively, or in addition, at least a portion of the map data 116 and/or the sensor data 119 can be located in one or more data stores 115 that are located remotely from the tow vehicle 102.

As noted above, the tow vehicle 102 can include the sensor system 120. The sensor system 120 can include one or more sensors. “Sensor” means any device, component and/or system that can detect, and/or sense something. The one or more sensors can be configured to detect, and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, the two or more sensors can form a sensor network. The sensor system 120 and/or the one or more sensors can be operatively connected to the processor(s) 110, the data store(s) 115, and/or another element of the tow vehicle 102 (including any of the elements shown in FIG. 1). The sensor system 120 can acquire data of at least a portion of the internal environment as well as the external environment of the tow vehicle 102 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensors 121. The vehicle sensor(s) 121 can detect, determine, and/or sense information about the tow vehicle 102 itself. In one or more arrangements, the vehicle sensor(s) 121 can be configured to detect, and/or sense position and orientation changes of the tow vehicle 102, such as, for example, based on inertial acceleration. In one or more arrangements, the vehicle sensor(s) 121 can include one or more accelerometers, one or more gyroscopes, an inertial measurement unit (IMU), a dead-reckoning system, a global navigation satellite system (GNSS), a global positioning system (GPS), a navigation system 147, and/or other suitable sensors. The vehicle sensor(s) 121 can be configured to detect, and/or sense one or more characteristics of the tow vehicle 102. In one or more arrangements, the vehicle sensor(s) 121 can include a speedometer to determine a current speed of the tow vehicle 102.

Alternatively, or in addition, the sensor system 120 can include one or more environment sensors 122 configured to acquire, and/or sense data around the vehicle. Sensor data around the vehicle can include information about the external environment in which the vehicle is located or one or more portions thereof.

As an example, the one or more environment sensors 122 can be configured to detect, quantify and/or sense vehicles or other objects in at least a portion of the external environment of the tow vehicle 102 and/or information/data about such vehicles or objects. In the external environment, the one or more environment sensors 122 can be configured to detect, measure, quantify, and/or sense vehicles and objects in the external environment of the tow vehicle 102, such as, for example, lane markers, signs, traffic lights, traffic signs, lane lines, crosswalks, curbs proximate the tow vehicle 102, off-road objects, electronic roadside devices, etc.

Various examples of sensors of the sensor system 120 will be described herein. The example sensors may be part of the one or more environment sensors 122 and/or the one or more vehicle sensors 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, the one or more cameras 126 can be high dynamic range (HDR) cameras or infrared (IR) cameras.

The tow vehicle 102 can include one or more communication modules 132. A “communication module” refers to a component designed to transmit and/or receive information from one source to another. The one or more communication modules 132 transmit and/or receive information via one or more communication networks. The communication network can include an internal vehicle communication network as well as an external communication network.

The internal vehicle communication network can include a bus in the tow vehicle 102 such as a controller area network (CAN) or the like, and/or other wired and/or wireless mechanisms. The elements of the tow vehicle 102 such as the data store 115, the sensor system 120, and the processor 110 may be communicatively linked to each other through the internal vehicle communication network. As used herein, the term “communicatively linked” can include direct or indirect connections through a communication channel or pathway or another component or system. Each of the elements of the tow vehicle 102 can include and/or execute suitable communication software, which enables the various elements to communicate with each other through the communication network and perform the functions disclosed herein.

The external communication network represents one or more mechanisms by which the tow vehicle 102 may communicate with other vehicles and/or objects, e.g., trailer vehicles, other vehicles, external servers, edge devices and/or roadside units. The external communication network can be implemented as, or include, without limitation, a wide area network (WAN), a local area network (LAN), the Public Switched Telephone Network (PSTN), a wireless network, a mobile network, a Virtual Private Network (VPN), the Internet, one or more intranets, vehicle-to-vehicle (V2V) communication, vehicle-to-cloud (V2C) communication, vehicle-to-infrastructure (V2I) communication, and/or some other form of vehicle-to-everything (V2X) wireless communication. The external communication network further can be implemented as or include one or more wireless networks, whether short-range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2 or long-range (e.g., a mobile, cellular, and/or satellite-based wireless network; GSM, TDMA, CDMA, WCDMA networks or the like). The communication module(s) 132 can include wired communication links and/or wireless communication links. The communication module(s) 132 can include any combination of the above networks and/or other types of networks.

The tow vehicle 102 can include an input system 130. An “input system” includes any device, component, system, element or arrangement or groups thereof that enable information/data to be entered into a machine. The input system 130 can receive an input from a user (e.g., a driver or a passenger). The input system may be located in a dashboard in the tow vehicle 102 or in any suitable location in the tow vehicle 102. Additionally and/or alternatively, the input system may be located on a mobile device. As an example, the input system can be an interface that the user can touch, press, turn, and/or speak to. In such an example, the input system 130 may be a knob, a slide, a switch, a touchscreen, a multi-touch screen, a keypad, display, button, joystick, mouse, trackball, microphone, gesture recognition (radar, lidar, camera, or ultrasound-based), and/or combinations thereof.

The tow vehicle 102 can include one or more output systems 135. An “output interface” includes any device, component, system, element or arrangement or groups thereof that enable information/data to be presented to a user (e.g., a person) or other entity. The output system(s) 135 can present information/data to a user or other entity. The output system(s) 135 can include a display, an earphone, haptic device, and/or speaker. Some components of the tow vehicle 102 may serve as both a component of the input system(s) 130 and a component of the output system(s) 135 such as a touchscreen. The output system(s) 135 may be located in a dashboard in the tow vehicle 102 or in any suitable location in the tow vehicle 102. Additionally and/or alternatively, the output system(s) 135 may be located on the mobile device.

The tow vehicle 102 can include one or more vehicle systems 140. Various examples of the one or more vehicle systems 140 are shown in FIG. 1. However, the tow vehicle 102 can include more, fewer, or different vehicle systems 140. It should be appreciated that although particular vehicle systems are separately defined, each or any of the systems or portions thereof may be otherwise combined or segregated via hardware and/or software within the tow vehicle 102. The tow vehicle 102 can include a propulsion system 141, a braking system 142, a steering system 143, throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the tow vehicle 102 and/or to determine a travel route for the tow vehicle 102. The navigation system 147 can include one or more mapping applications to determine a travel route for the tow vehicle 102 and/or the trailer vehicle. The navigation system 147 can include a global positioning system, a local positioning system or a geolocation system.

The tow vehicle 102 can include one or more autonomous driving systems 160. The autonomous driving system 160 can include one or more devices, applications, and/or combinations thereof, now known or later developed, configured to control the movement, speed, maneuvering, heading, direction, etc. of the tow vehicle 102. The autonomous driving system 160 can include one or more driver assistance systems such as a lane keeping system, a lane centering system, a collision avoidance system, and/or a driver monitoring system.

The autonomous driving system(s) 160 can be configured to receive data from the sensor system 120 and/or any other type of system capable of capturing information relating to the tow vehicle 102 and/or the external environment of the tow vehicle 102. In one or more arrangements, the autonomous driving system(s) 160 can use such data to generate one or more driving scene models. The autonomous driving system(s) 160 can determine position and velocity of the tow vehicle 102. The autonomous driving system(s) 160 can determine the location of obstacles, obstacles, or other environmental features including traffic signs, trees, shrubs, neighboring vehicles, pedestrians, etc.

The tow vehicle 102 can include one or more actuators 150. The actuators 150 can be any element or combination of elements operable to modify, adjust and/or alter one or more of the vehicle systems 140 or components thereof to responsive to receiving signals or other inputs from the processor(s) 110 and/or the autonomous driving system(s) 160. Any suitable actuator can be used. For instance, the one or more actuators 150 can include motors, pneumatic actuators, hydraulic pistons, relays, solenoids, and/or piezoelectric actuators, just to name a few possibilities.

The tow vehicle 102 can include one or more modules, at least some of which are described herein. The modules can be implemented as computer-readable program code that, when executed by a processor 110, implement one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store 115 may contain such instructions.

In one or more arrangements, one or more of the modules described herein can include artificial or computational intelligence elements, e.g., neural network, fuzzy logic or other machine learning algorithms. Further, in one or more arrangements, one or more of the modules can be distributed among a plurality of the modules described herein. In one or more arrangements, two or more of the modules described herein can be combined into a single module.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-4 but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, modules, as used herein, include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A method comprising:
receiving sensor data about at least one vehicle between a tow vehicle and at least one trailer vehicle;
outputting, using an output system, information related to the at least one vehicle and the at least one trailer vehicle based on the sensor data;
receiving from a user, using an input system, a new position for at least one trailer vehicle relative to the at least one vehicle; and
transmitting the new position to the at least one trailer vehicle.

2. The method of claim 1, further comprising:
determining a route to the new position;
generating at least one instruction based on the route; and
transmitting at least one of the route or the at least one instruction to the at least one trailer vehicle.

3. The method of claim 1, further comprising:
determining a status update of the at least one trailer vehicle.

4. The method of claim 1, wherein the information comprises at least one of:
a relative position of the tow vehicle;
a relative position of the at least one vehicle;
a relative position of the at one least trailer vehicle;
a speed of the tow vehicle;
a speed of the at least one vehicle;
a speed of the at least one trailer vehicle; and
an estimate of time for the at least one trailer vehicle to be behind the tow vehicle with no other vehicle in between the tow vehicle and the at least one trailer vehicle.

5. The method of claim 1, further comprising:
determining whether a condition has been met; and
outputting, using the output system, an alert based on determining that the condition has been met.

6. The method of claim 5, wherein the condition is at least of:
a distance between the tow vehicle and the at least one trailer vehicle exceeding predetermined distance; or
a number of vehicles between the tow vehicle and the at least one trailer vehicle exceeding a predetermined number.

7. The method of claim 1, wherein at least two vehicles are between the tow vehicle and the at least one trailer vehicle; and
the new position is in between the at least two vehicles.

8. A system comprising:
a processor; and
a memory storing machine-readable instructions that, when executed by the processor, cause the processor to:
receive sensor data about at least one vehicle between a tow vehicle and at least one trailer vehicle;
output, using an output system, information related to the at least one vehicle and the at least one trailer vehicle based on the sensor data;
receive from a user, using an input system, a new position for at least one trailer vehicle relative to the at least one vehicle; and
transmit the new position to the at least one trailer vehicle.

9. The system of claim 8, wherein the machine-readable instructions further include machine-readable instructions that, when executed by the processor, cause the processor to:
determine a route to the new position;
generate at least one instruction based on the route; and
transmit at least one of the route or the at least one instruction to the at least one trailer vehicle.

10. The system of claim 8, wherein the machine-readable instructions further include machine-readable instructions that, when executed by the processor, cause the processor to:
determine a status update of the at least one trailer vehicle.

11. The system of claim 8, wherein the information comprises at least one of:
a relative position of the tow vehicle;
a relative position of the at least one vehicle;
a relative position of the at one least trailer vehicle;
a speed of the tow vehicle;
a speed of the at least one vehicle;
a speed of the at least one trailer vehicle; and
an estimate of time for the at least one trailer vehicle to be behind the tow vehicle with no other vehicle in between the tow vehicle and the at least one trailer vehicle.

12. The system of claim 8, wherein the machine-readable instructions further include machine-readable instructions that, when executed by the processor, cause the processor to:
determine whether a condition has been met; and
output, using the output system, an alert based on determining that the condition has been met.

13. The system of claim 12, wherein the condition is at least of:
a distance between the tow vehicle and the at least one trailer vehicle exceeding predetermined distance; or
a number of vehicles between the tow vehicle and the at least one trailer vehicle exceeding a predetermined number.

14. The system of claim 8, wherein at least two vehicles are between the tow vehicle and the at least one trailer vehicle; and
the new position is in between the at least two vehicles.

15. A non-transitory computer-readable medium including machine-readable instructions that, when executed by a processor, cause the processor to:
receive sensor data about at least one vehicle between a tow vehicle and at least one trailer vehicle;
output, using an output system, information related to the at least one vehicle and the at least one trailer vehicle based on the sensor data;
receive from a user, using an input system, a new position for at least one trailer vehicle relative to the at least one vehicle; and
transmit the new position to the at least one trailer vehicle.

16. The non-transitory computer-readable medium of claim 15, wherein the machine-readable instructions further include machine-readable instructions that, when executed by the processor, cause the processor to:
determine a route to the new position;
generate at least one instruction based on the route; and
transmit at least one of the route or the at least one instruction to the at least one trailer vehicle.

17. The non-transitory computer-readable medium of claim 15, wherein the machine-readable instructions further include machine-readable instructions that, when executed by the processor, cause the processor to:
determine a status update of the at least one trailer vehicle.

18. The non-transitory computer-readable medium of claim 15, wherein the information comprises at least one of:
a relative position of the tow vehicle;
a relative position of the at least one vehicle;
a relative position of the at one least trailer vehicle;
a speed of the tow vehicle;
a speed of the at least one vehicle;
a speed of the at least one trailer vehicle; and
an estimate of time for the at least one trailer vehicle to be behind the tow vehicle with no other vehicle in between the tow vehicle and the at least one trailer vehicle.

19. The non-transitory computer-readable medium of claim 15, wherein the machine-readable instructions further include machine-readable instructions that, when executed by the processor, cause the processor to:
determine whether a condition has been met; and
output, using the output system, an alert based on determining that the condition has been met.

20. The non-transitory computer-readable medium of claim 19, wherein the condition is at least of:
a distance between the tow vehicle and the at least one trailer vehicle exceeding predetermined distance; or
a number of vehicles between the tow vehicle and the at least one trailer vehicle exceeding a predetermined number.
